(19) United States
(12) Patent Application Publication
(10) Pub. No.: US 2006/0217056 A1
(43) Pub. Date: Sep. 28, 2006

(54) Fan/filter unit and clean booth equipeed therewith

(75) Inventors: Osamu Gomi, Suwa (JP); Hitoshi Nakao, Suwa (JP); Kengo Honma, Chino (JP); Motoki Itoda, Suwa (JP); Takahiro Tanaka, Chino (JP); Kazuhiro Suzuki, Nishisou (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/369,923

(22) Filed: Mar. 7, 2006

(30) Foreign Application Priority Data
Mar. 25, 2005 (JP) 2005-090086

(51) Int. Cl. F24F 3/16; B01L 1/04

(52) U.S. Cl. 454/187; 55/385.2; 55/473

(57) ABSTRACT

A fan/filter unit includes a casing having formed an air outlet port on a front side thereof and an air inlet port on a rear side thereof; a fan housed in the casing so as to face the air inlet port; a filter housed in the casing so as to face the air outlet port such that the air discharged by the fan in a widthwise direction of the casing is blown forward through the filter. The fan/filter unit has a shielding plate disposed between the fan and the filter as seen in a depthwise direction of the casing so that the shielding plate shields an associated flow of air flowing in a direction from the filter to the fan.

The entire disclosure of Japanese Patent Application No. 2005-90086, filed Mar. 25, 2005, is expressly incorporated by reference herein.

### BACKGROUND

1. Technical Field

The present invention relates to a fan/filter unit (i.e., a unit made up of a combination of a fan and a filter) which is to be installed in a clean booth (i.e., a clean room on a small scale), as well as a clean booth equipped with the fan/filter unit.

2. Related Art

Conventionally, as this kind of fan/filter unit, there is known one which is made up of: a chamber which has a filter on a front side and a turbo fan on a rear side; a shielding plate which is provided so as to partition the space between the turbo fan and the filter and which has formed a port in the neighborhood of a center; and a dispersion plate which is provided on a side of the filter away from the shielding plate so as to cover the port and which is constituted by a punched metal. JP-A-11-132527 is an example of related art.

In this arrangement, the air blown out of the turbo fan is delivered toward left and right side plates of the chamber and further forward upon reflection on the side plates. The air, however, is shielded by the shielding plate and therefore goes forward to the central port along the shielding plate. Thereafter, the air is branched to the portion which goes round (i.e., goes to the opposite side of) the shielding plate and the portion which comes into collision with the dispersion plate. The air which has gone round the shielding plate is exhausted forward through the filter, and the air coming into collision with the dispersion plate passes through punched holes of a punched metal and is exhausted forward through the filter.

In this kind of fan/filter unit, the air passing through the port forms a relatively uniform flow at the point of time of passing through the filter due to the air flow which passes through the dispersion plate itself and to the air flow to be dispersed into both sides of the dispersion plate. However, the left and right air flows flowing toward the port before reaching the port are forced to flow along the shielding plate and, due to an associated flow (or an adjoining flow) to be generated in the neighborhood of the fan, are forced to flow in a manner to be attracted toward the fan. Therefore, the flow in the left-and-right (i.e., widthwise) direction which forms counter flow comes into collision at the port with a strong directivity in the left and right directions, resulting in cancellation of the flow velocity. In this manner, there is a problem in that, while the air can be discharged in a uniform manner, sufficient characteristics of running straight cannot be maintained due to a sharp drop in the flow velocity.

### SUMMARY

It is an advantage of the invention to provide a fan/filter unit which is capable of delivering air having straight-running characteristics in a uniform manner, as well as, to provide a clean booth which is provided with the fan/filter unit.

According to an aspect of the invention, there is provided a fan/filter unit comprising: a casing having formed an air outlet port on a front side thereof and an air inlet port on a rear side thereof; a fan housed in the casing so as to face the air inlet port; a filter housed in the casing so as to face the air outlet port such that the air discharged by the fan in a widthwise direction of the casing is blown forward through the filter. The fan/filter unit has a shielding plate disposed between the fan and the filter as seen in a depthwise direction of the casing so that the shielding plate shields an associated flow of air flowing in a direction from the filter to the fan.

According to this arrangement, the air discharged from the fan flows to the right and left (i.e., in the widthwise direction of the casing) and, due to the side plates of the casing, forward or partly obliquely forward. The counter flow of air obliquely directed in the widthwise direction is prevented from generating an associated flow due to the presence of the shield plate. Therefore, without being attracted toward the fan, the air flows directly forward through the filter. In this manner, the air can be delivered without lowering the flow velocity, and it is thus possible to deliver from the filter the air which is uniform and high in straight-running characteristics.

According to another aspect of the invention, there is provided a fan/filter unit comprising: a casing having formed an air outlet port on a front side thereof and an air inlet port on a rear side thereof; a fan housed in the casing so as to face the air inlet port; a filter housed in the casing so as to face the air outlet port such that the air discharged by the fan in a widthwise direction of the casing is blown forward through the filter. The fan/filter unit has a pair of inward-direction plates so constructed and arranged that a flow of air reflected from widthwise side walls toward the filter is directed to a widthwise midway portion of the filter.

According to this arrangement, the air discharged from the fan flows in the widthwise direction and, due to the side plates of the casing as well as to the inward-direction plates, flows in a manner directed obliquely forward. Therefore, part of the air joins together in the widthwise midway portion before the filter, thereafter flowing forward. As a result of pressure increase due to this joining together of the air, the counter flow of air in the widthwise direction flows forward by going around along front sides of the respective inward-direction plates (i.e., by going into the space defined by the inward-direction plates and the filter). In this manner, since the air can be delivered without lowering the flow velocity, there can be delivered air which is uniform and high in straight-running characteristics from the filter.

According to still another aspect of the invention, there is provided a fan/filter unit comprising: a casing having formed an air outlet port on a front side thereof and an air inlet port on a rear side thereof; a fan housed in the casing so as to face the air inlet port; a filter housed in the casing so as to face the air outlet port such that the air discharged by the fan in a widthwise direction of the casing is blown forward through the filter. The fan/filter unit has an outward-direction plate so constructed and arranged that a counter flow of air flowing in the widthwise direction along the filter toward a widthwise midway portion thereof is directed to the filter at the midway portion.

According to this arrangement, the air discharged from the fan flows in the widthwise direction and, due to the respective side plates of the casing, flows forward or partly obliquely forward. The counter flow of air in the widthwise direction directed obliquely forward is further directed forward by means of the outward-direction plate at the widthwise midway portion on a rear side of the filter. As a result, the counter flow of air in the widthwise direction flows forward and passes through the filter. In this manner, the air can be delivered without lowering the flow velocity, and it is possible to deliver the air which is uniform and high in straight-running characteristics.

According to yet another aspect of the invention, there is provided a fan/filter unit comprising: a casing having formed an air outlet port on a front side thereof and an air inlet port on a rear side thereof; a fan housed in the casing so as to face the air inlet port; a filter housed in the casing so as to face the air outlet port such that the air discharged by the fan in a widthwise direction of the casing is blown forward through the filter. The fan/filter unit has: a shielding plate disposed between the fan and the filter as seen in a depthwise direction of the casing so that the shielding plate shields an associated flow of air to flow in a direction from the filter to the fan; a pair of left and right inward-direction shielding plates so constructed and arranged that a flow of air reflected from widthwise side walls toward the filter is directed to a widthwise midway portion of the filter; and an outward-direction plate so constructed and arranged that a counter flow of air flowing in the widthwise direction along the filter toward a widthwise midway portion thereof is directed to the filter at the midway portion.

According to this arrangement, the air discharged from the fan flows in the widthwise direction and, due to the respective side plates of the casing as well as to the respective inward-direction plates, is directed obliquely forward. The counter flow of air in the widthwise direction directed obliquely forward is prevented by the shielding plate from generating an associated flow, and is further directed forward in the midway portion on the rear side of the filter (i.e., on that side of the filter which faces the shielding plate) by means of the outward-direction plate. Further, as a result of pressure increase in the midway portion, part of the counter flow of air in the widthwise direction flows forward by going around the respective inward-direction plates (i.e., by going into the space defined by the inward-direction plate and the filter). Therefore, the flow of air becomes smooth and the air can be delivered without lowering the flow velocity. It is thus possible to deliver the air which is uniform and high in the straight-running characteristics.

It is preferable that the shielding plate and each of the inward-direction plates are respectively disposed at a distance from each other as seen in the widthwise direction.

According to this arrangement, since a large space can be maintained between the shielding plate and each of the inward-direction plates, the flow of air can be guided smoothly.

It is preferable that each of the inward-direction plates is disposed at a distance to the filter as seen in the depthwise direction of the casing.

According to this arrangement, the air guided by each of the inward-direction plates flows by flowing around each of the inward-direction plates (i.e., by flowing into the space defined by the inward-direction plate and the filter).

It is preferable that sidewise outer ends of the shielding plate are respectively bent rearward.

According to this arrangement, there can be formed a wider air introduction portion between the shielding plate and each of the inward-direction plates. Therefore, the air flow can be guided smoothly.

It is preferable that the shielding plate is connected to both widthwise ends of the outward-direction plate, and is constituted by a left shielding portion and a right shielding portion which are respectively elongated outward on the widthwise sides from the outward-direction plate.

According to this arrangement, the counter flow of air in the widthwise direction is prevented by the right and left shielding portions from giving rise to an associated flow. Therefore, the flow of air can be delivered forward.

It is preferable that the shielding plate and the outward-direction plate are integrally formed.

According to this arrangement, by integrally forming the shielding plate and the outward-direction plate, the flow of the air can be made smooth and the two members can be easily formed by, e.g., stamping (pressing) or the like.

It is preferable that the outward-direction plate is constituted by a left-side direction plate portion and a right-side direction plate portion which are respectively elongated rearward and outward from an apex portion at the widthwise midway portion of the filter.

According to this arrangement, the flow of air coming from the widthwise direction can be delivered toward the apex portion. As a result, the flow of air can be guided in the forward direction.

It is preferable that the right-direction plate portion and the left-direction plate portion are respectively elongated obliquely rearward while forming bent portions.

According to this arrangement, the flow of air coming from the widthwise direction can be introduced to the apex portion without lowering the flow velocity. As a result, the flow of air can be smoothly guided in the forward direction.

It is preferable that the apex portion is substantially in abutment with the filter.

According to this arrangement, the air delivered to the apex portion can be delivered to the filter as it is without collision of counter flow of air flowing in the left and right directions.

It is preferable that each of the inward-direction plates is elongated obliquely forward with one end thereof being in abutment with each of the side walls of the casing.

According to this arrangement the air blown out of the fan can be delivered obliquely forward. As a result, the flow of air can be guided to the widthwise center of the filter.

It is preferable that each of the inward-direction plates is elongated obliquely forward while forming a bent portion.

According to this arrangement, the flow of air blown out of the fan can be smoothly guided obliquely forward and to the widthwise center of the filter without lowering the flow velocity.

According to another aspect of the invention, there is provided a clean booth having mounted on a ceiling portion the above-referenced fan/filter unit.

According to this arrangement, clean air which is superior in straight-running characteristics is discharged from the filter. Therefore, clean space can be maintained without the air flow in the direction of discharging giving rise to turbulences. Particularly, clean air can be directly blown to an apparatus or the like which is mounted on a working table.

### BRIEF DESCRIPTION OF THE DRAWINGS

The invention will be described with reference to the accompanying drawings, wherein like numbers reference like elements.

FIG. 1A and FIG. 1B are rear view and sectional view, respectively, of a fan/filter unit according to an embodiment of the invention.

FIG. 2A and FIG. 2B are rear view and sectional view, respectively, of a fan/filter unit according to a modified example of the invention.

FIG. 3 is an external perspective view of a clean booth which is equipped with the fan/filter unit according to the embodiment of the invention.

### DESCRIPTION OF EXEMPLARY EMBODIMENTS

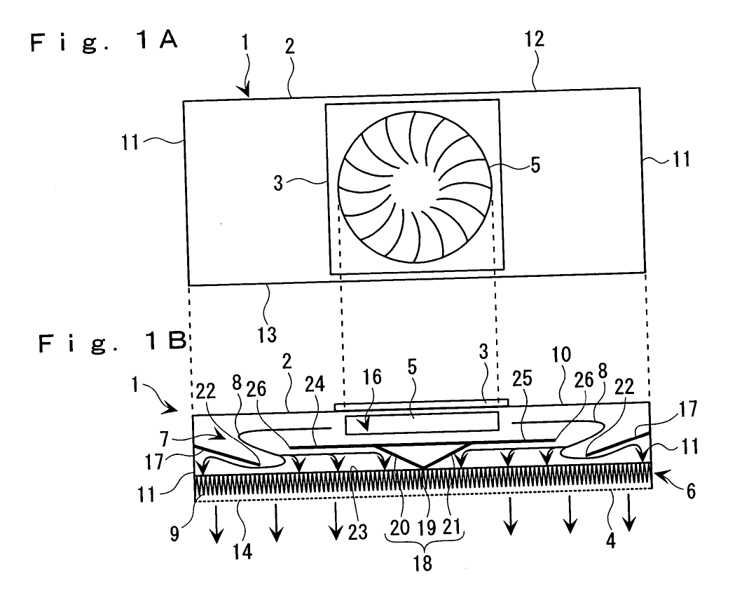

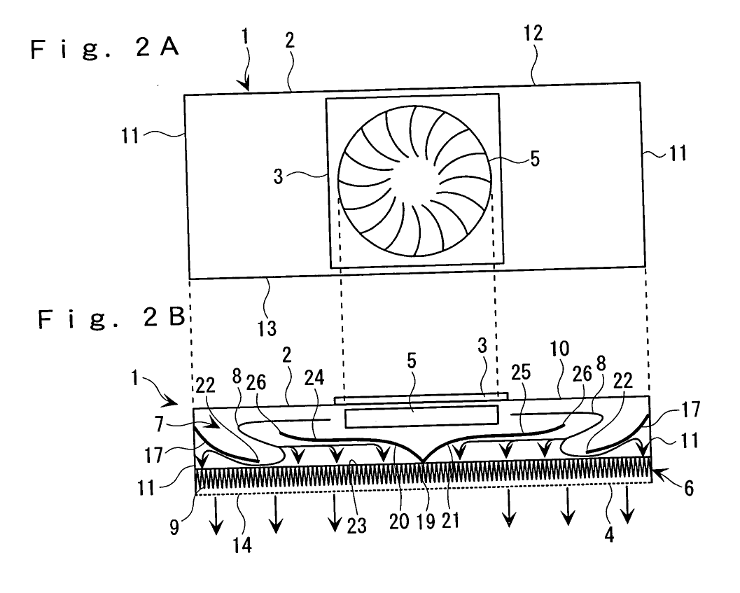

With reference to the accompanying drawings, a description will now be made about a fan/filter unit according to an embodiment of the invention. The fan/filter unit sucks outside air from a rear side and discharges clean air through a filter which is disposed on a front side. In this specification, the directional relationship is defined as seen in FIG. 1B (or FIG. 2B). Namely, the direction from the left to the right (or vice versa) is defined as “widthwise direction” and the direction crossing thereto at right angles is defined as “depthwise direction.” The upper side and the lower side as illustrated in FIG. 1B (or FIG. 2B) are respectively referred to as “rear side” and “front side” of the fan/filter unit (or the casing). A clean booth which is equipped with the fan/filter unit introduces outside air by using the fan/filter unit to discharge clean air into the booth through the fan/filter unit, thereby obtaining a space which is high in the degree of cleanliness.

FIGS. 1A and 1B show a rear view and a sectional view, respectively, of a fan/filter unit (FFU). As shown therein, the fan/filter unit 1 is made up of: a casing 2 which constitutes a chamber; an air suction port 3 which is formed in a rear central part of the casing 2; an air discharge port 4 which is formed in an entire front region of the casing 2; a fan 5 which is disposed in the casing 2 so as to face the air suction port 3; a filter 6 which is mounted on the air discharge port 4; and a group of partition plates 7. The air sucked through the air suction port 3 as a result of rotation of the fan 5 is subjected to the adjustment of flow direction 8 by means of the group of partition plates 7, and is discharged as clean air through the filter 6.

The casing 2 is made up of: a rear plate 10; left and right side plates 11; an upper (ceiling) plate 12; and a lower (bottom) plate 13 (“upper” and “lower” refer to the positional relationship as illustrated in FIG. 1A), all of which are made of stainless steel or steel. In the center of the rear plate 10 there is provided the air suction port 3. In the portion which corresponds to a front plate of the casing 2, there is built-in (or fit in position) the filter 6. The casing 2 is thus formed into a size of building modular standard, e.g., of 1,200 W×600 H×225 D, or the like. The air suction port 3 is formed into a rectangular shape which is slightly larger than an impeller wheel of the fan 5, taking into consideration the necessity of reinforcement around the port, and has a meshed pre-filter (not shown). Although not shown in the figures, the air discharge port 4 is provided with fittings for mounting the filter 6 in position.

The fan 5 is constituted by a centrifugal fan such as a turbo fan or the like which sucks outside air from the air suction port 3 to centrifugally discharge it in the peripheral direction. The air centrifugally discharged in the peripheral direction is directed to the widthwise (or left-and-right) directions while being guided by the upper plate 12 and the lower plate 13 of the casing 2. The filter 6 is a so-called high-efficiency particulate air (HEPA) filter and is made up of: a filter element 9; a frame 23 which encloses the four corners of the filter element 9; and a filter element holder (punched metal) 14 which extends on both front and rear sides of the frame 23 to hold the filter element 9 in position. The filter 6 is constituted in a manner attachable to and detachable from the air discharge port 4, i.e., in the form of a replaceable cassette.

The group of partition plates 7 are interposed in a space between the fan 5 and the filter 6 as seen in the depthwise direction thereof and is made up of: a shielding plate 16 which is disposed in the center as seen in the widthwise direction (also referred to as “widthwise center”) so as to partition the space between the fan 5 and the filter 6; a pair of left and right inward-direction plates (i.e., left plate and right plate respectively directed inward as seen in the widthwise direction) 17 which are disposed outward of the shielding plate 16 at a distance to the shielding plate 16 on the left and right sides, respectively; and an outward-direction plate (i.e., a plate directed outward as seen in the widthwise direction) 18 which is added to the front central portion of the shielding plate 16 in a manner to project forward (i.e., to the front side). The shielding plate 16, the inward-direction plates 17 and the outward-direction plate 18 are made of stainless steel plates or steel plates in the same manner as the casing 2.

The shielding plate 16 serves the function to shield that part of air which is attracted from the filter side to the fan side as an associated flow (or an adjoining flow) of the air blown out of the fan 5. The shielding plate 16 is disposed substantially midway of the space between the rear plate 10 and the filter 6 as seen in the depthwise direction of the casing 2, so as to lie parallel to the rear plate 10 and the filter 6. The upper end of the shielding plate 16 is in abutment with the upper plate 12, and the lower end thereof is in abutment with the lower plate 13, whereby the shielding plate 16 as a whole is formed into a rectangular shape. The width of the shielding plate 16 shall be of a dimension which shields the associated flow but which does not shield the forward flow of air as guided by both the side plates 11. It is therefore determined depending on the characteristics of the fan 5 and the inner width of the casing 3.

The inward-direction plates 17 serve the function to guide the flow of air flowing forward as guided by each of the side plates 11 further to the center of the filter 6 as-seen in the widthwise direction of the filter 6 (i.e., widthwise center of the filter 6 as seen in FIG. 1B). The inward-direction plates 17 are elongated in an obliquely forward direction with one end thereof being in abutment with the respective side plates 11. In this case, too, the upper end of each of the inward-direction plates 17 is in abutment with the upper plate 12, and the lower end thereof is in abutment with the lower plate 13, whereby the inward-direction plate 17 as a whole is formed into a rectangular shape. The other end 22 (i.e., the front or free end as seen in the direction of elongation) of each of the inward-direction plates 17 is disposed at a sufficient clearance to the shielding plate 16 as seen in the widthwise direction of the casing 2 and also at an adequate clearance to the filter 6 as seen in the depthwise direction thereof. In other words, the former clearance is designed not to block the flow of the air toward the filter 6, and the latter clearance is designed so that the air flows round to the front side of the shielding plate 16 (i.e., flows into the space between the filter 6 and the respective inward-direction plates 17).

The outward-direction plate 18 serves the function to guide the flow of air lead obliquely forward by each of the inward-directing plates 17 toward the filter 6 which is located on the front side of the shielding plate 16, and is disposed so as to form a shallow V-shaped projection in the front central portion thereof. In this case, too, the outward-direction plate 18 is formed such that the upper end thereof is in abutment with the upper plate 12 and that the lower end thereof is in abutment with the lower plate 13, whereby the outward-direction plate 18 is formed into a shallow V-shape in cross section and in a rectangle as seen from the front side thereof. In other words, the outward-direction plate 18 is formed by bending a rectangular flat plate at a widthwise central position, thereby forming a left guide plate portion 20 and a right guide plate portion 21 with an apex portion 19 being in the center. The apex portion 19 of the outward-direction plate 18 is disposed so as to be in abutment with an inner surface of the widthwise central portion of the filter 6 so that the left and right counter flows of air do not collide upstream of (or before) the filter 6. The width of the outward-direction plate 18 and the angle to the shielding plate 16 are determined depending on the flow velocity and flow amount of air introduced into the obliquely forward portion by means of the inward-direction plate 17.

A description will now be made about a series of air flows to be adjusted by both the inward-direction plates 17 and the outward-direction plate 18. The air blown out of the fan 5 is discharged toward both the left and right side plates 11 and is directed obliquely forward by means of the pair of left and right inward-direction plates 17. At this time, since a large clearance is secured between each of the inward-direction plates 17 and the shielding plate 16, the flow of air can be smoothly guided forward. Further, part of the left and right counter flows of air directed obliquely forward is prevented by the shielding plate 16 from generating an associated flow which is sucked to the fan 5, and the air coming from the left and right sides is delivered forward by means of the outward-direction plate 18. According to this arrangement, the flow of air can be guided forward without collision in the widthwise central part of the casing 2 and, therefore, can pass through the filter 6 as it is. In addition, the air pressure rises in the widthwise center and, as a consequence, part of the counter flow of air flowing in the left and right directions goes around each of the inward-direction plates 17 (i.e., goes into the space defined by the inward-direction plate and the filter 6), whereby the air is spread over the entire region of the filter 6 while maintaining the characteristics of running or flowing straight forward. Accordingly, the flow of air becomes smooth and can be discharged forward without losing the flow velocity.

According to the above arrangement, it is possible to discharge, from the filter 6 of the fan/filter unit 1, clean air which is uniform and high in the characteristics of running straight (i.e., high in flow velocity). It is to be noted that the shielding plate 16, the inward-direction plates 17, and the outward-direction plate 18 are capable of smoothly discharging air respectively (i.e., independent of the others). Therefore, each of them can be used as a single unit (without combining the others) to smoothly discharge from the filter 6 uniform air which is high in the characteristics of running straight. In other words, although in the above-referenced embodiment, a combination of a group of three kinds of partition plates 7 are used, at least one kind of the partition plates may be used in constituting the fan/filter unit.

Next, with reference to FIGS. 2A and 2B, a description will be made about a modified embodiment of a group of the partition plates 7. According to the group of the partition plates 7 of this modified embodiment, the shielding plate 16 and the outward-direction plates 18 are integrally formed. The shielding plate 16 is made up of a left shielding plate portion 24 and a right shielding plate portion 25. The left shielding plate portion 24 is in continuation to the left guide plate portion 20 of the outward-direction plate 18, and the right shielding plate portion 25 is in continuation to the right guide plate portion 21 of the outward-direction plate 18. The left guide plate portion 20 and the right guide plate portion 21 are formed in a bent manner so as to form a rearward projection, respectively. The outer end portions 26 of the left shielding plate portion 24 and the right shielding plate portion 25 are bent to form a forward projection so as to secure a wide space between each of the shielding plate portions 24, 25 and each of the inward-direction plates 17. The shielding plate 16, both the inward-direction plates 17 and the outward-direction plate 18 are formed by stamping.

According to this arrangement, since the air to flow along the shielding plate 16, both the inward-direction plates 17, and the outward-direction plate 18 can be smoothly guided by the group of bent partition plates 7, the pressure loss of the air can be restricted. Therefore, it becomes possible to discharge, from the filter 6, air which is more uniform and higher in straight-running characteristics than the case with the above-referenced embodiment.

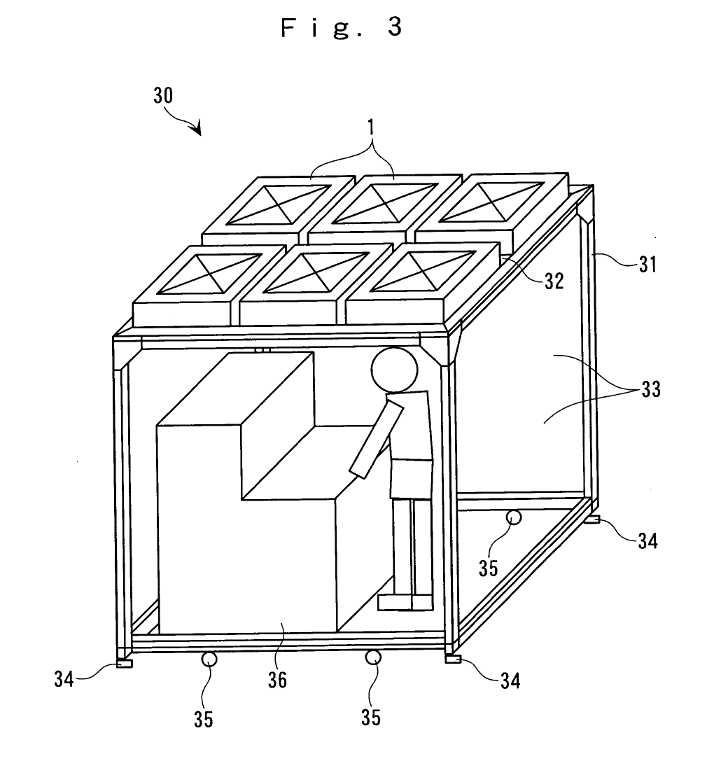

With reference to FIG. 3, a description will now be made about a clean booth 30 which is equipped with the fan/filter unit 1 according to the above embodiments. As shown in FIG. 3, the clean booth 30 is disposed so as to enclose therein a manufacturing apparatus 36 which is an object to be kept clean. Clean air is blown from a plurality of (in the embodiment, six) fan/filter units 1 which are disposed on the ceiling in a manner to look downward toward the manufacturing apparatus 36, and is then exhausted sidewise along the floor.

The clean booth 30 is made up of: a booth frame 31 which is structured into a rectangular parallelepiped; a ceiling plate 32 which forms an upper wall; four sheets of vinyl curtains 33 which constitute side walls; four legs 34 and four casters 35 which are attached to lower ends of the booth frame 31; and six fan/filter units 1 which are disposed over the entire region of the ceiling plate 32 without a clearance between respective units 1. Each of the fan/filter units 1 is mounted to look downward so that the clean air can be discharged downward. The booth frame 31 is constituted in a manner capable of being taken into pieces, by forming with light-gauge structural members, or the like with each part being coupled together by means of screws, or the like. Each of the vinyl curtains 33 is constituted by an antistatic transparent curtain. The vinyl curtain 33 which serves as the inlet to, and outlet from, the clean booth 30 is made up of a double-curtain construction.

The clean booth 30 according to this embodiment has a bottom area decided by taking into consideration a projected area (i.e., plan size) of the manufacturing apparatus 36, an accompanied working table, parts stocker, or the like as well as the working space. The height thereof is designed to be about 2000 mm taking into consideration the height of an operator. As described above, clean air which is high in straight-running characteristics is discharged downward from each of the fan/filter units 1. In concrete, the air maintains the straight-running characteristics from the surface of the filter 6 down to a lower position which is about 1000 mm from the surface of the filter 6. In this manner, since clean air can be directly delivered to the working position (1000 mm-1500 mm above the floor surface) in which desired cleanliness is required, the desired cleanliness can be surely obtained.

In case the cleanliness is only partially required in the clean booth 30, the number of the fan/filter units 1 may be reduced so that the fan/filter units 1 are disposed right above the position at which cleanliness is required.

It is further understood by those skilled in the art that the foregoing is the preferred embodiments of the invention, and that various changes and modifications may be made without departing from the spirit and scope thereof.

What is claimed is:

1. A fan/filter unit comprising:
a casing having formed an air outlet port on a front side thereof and an air inlet port on a rear side thereof;
a fan housed in the casing so as to face the air inlet port;
a filter housed in the casing so as to face the air outlet port such that the air discharged by the fan in a widthwise direction of the casing is blown forward through the filter,
wherein the fan/filter unit has a shielding plate disposed between the fan and the filter as seen in a depthwise direction of the casing so that the shielding plate shields an associated flow of air flowing in a direction from the filter to the fan.

2. A fan/filter unit comprising:
a casing having formed an air outlet port on a front side thereof and an air inlet port on a rear side thereof;
a fan housed in the casing so as to face the air inlet port;
a filter housed in the casing so as to face the air outlet port such that the air discharged by the fan in a widthwise direction of the casing is blown forward through the filter,
wherein the fan/filter unit has a pair of inward-direction plates so constructed and arranged that a flow of air reflected from widthwise side walls toward the filter is directed to a widthwise midway portion of the filter.

3. A fan/filter unit comprising:
a casing having formed an air outlet port on a front side thereof and an air inlet port on a rear side thereof;
a fan housed in the casing so as to face the air inlet port;
a filter housed in the casing so as to face the air outlet port such that the air discharged by the fan in a widthwise direction of the casing is blown forward through the filter,
wherein the fan/filter unit has an outward-direction plate so constructed and arranged that a counter flow of air flowing in the widthwise direction along the filter toward a midway portion thereof as seen in the widthwise direction is directed to the filter at the midway portion.

4. A fan/filter unit comprising:
a casing having formed an air outlet port on a front side thereof and an air inlet port on a rear side thereof;
a fan housed in the casing so as to face the air inlet port;
a filter housed in the casing so as to face the air outlet port such that the air discharged by the fan in a widthwise direction is blown forward through the filter,
wherein the fan/filter unit has: a shielding plate disposed between the fan and the filter as seen in a depthwise direction of the casing so that the shielding plate shields an associated flow of air to flow in a direction from the filter to the fan; a pair of left and right inward-direction shielding plates so constructed and arranged that a flow of air reflected from left and right side walls toward the filter is directed to a midway portion of the filter as seen in a widthwise direction thereof; and an outward-direction plate so constructed and arranged that a counter flow of air flowing in the widthwise direction along the filter toward a midway portion thereof as seen in the widthwise direction is directed to the filter at the midway portion.

5. The fan/filter unit according to claim 4, wherein the shielding plate and each of the inward-direction plates are respectively disposed at a distance from each other as seen in the widthwise direction.

6. The fan/filter unit according to claim 2, wherein each of the inward-direction plates is disposed at a distance to the filter as seen in the depthwise direction of the casing.

7. The fan/filter unit according to claim 1, wherein widthwise outer ends of the shielding plate are respectively bent rearward.

8. The fan/filter unit according to claim 4, wherein the shielding plate is connected to both widthwise ends of the outward-direction plate, and is constituted by a left shielding portion and a right shielding portion which are respectively elongated outward on the widthwise sides from the outward-direction plate.

9. The fan/filter unit according to claim 8, wherein the shielding plate and the outward-direction plate are integrally formed.

10. The fan/filter unit according to claim 3, wherein the outward-direction plate is constituted by a left-side direction plate portion and a right-side direction plate portion which are respectively elongated rearward and outward from an apex portion at the midway portion, as seen in the widthwise direction, of the filter.

11. The fan/filter unit according to claim 10, wherein the right-direction plate portion and the left-direction plate portion are respectively elongated obliquely rearward while forming bent portions.

12. The fan/filter unit according to claim 10, wherein the apex portion is substantially in abutment with the filter.

13. The fan/filter unit according to claim 2, wherein each of the inward-direction plates is elongated obliquely forward with one end thereof being in abutment with each of the side walls of the casing.

14. The fan/filter unit according to claim 13, wherein each of the inward-direction plates is elongated obliquely forward while forming a bent portion.

15. A clean booth having mounted on a ceiling portion the fan/filter unit according to claim 1.
